(19) United States
(12) Patent Application Publication
(10) Pub. No.: US 2018/0162504 A1
(43) Pub. Date: Jun. 14, 2018

(54) System and Method For Using A Combination Of Multiple Autonomous Vehicles With Different Abilities, Working Together As A System For Subsea Oil and Gas Exploration

(71) Applicant: Oceaneering International, Inc., Houston, TX (US)

(72) Inventor: Steffan Kruse Lindsø, Hafrsfjord (NO)

(73) Assignee: Oceaneering International, Inc., Houston, TX (US)

(21) Appl. No.: 15/840,722

(22) Filed: Dec. 13, 2017

Related U.S. Application Data
(60) Provisional application No. 62/433,698, filed on Dec. 13, 2016.

(51) Int. Cl. B63G 8/00; E21B 47/00; B63B 35/40; G05D 1/00; H04Q 9/00

(52) U.S. Cl. CPC B63G 8/001; E21B 47/00; B63B 35/40; G05D 1/0088; B63B 2035/007; H04Q 9/00; B63G 2008/004; B63G 2008/005; G05D 1/0038

(57) ABSTRACT

A system may be used to survey subsea sites using a remotely operated vehicle (ROV), an autonomous surface vessel (ASV) configured to serve as a communications link to subsea assets and relay data from the control station to the subsea assets where the ASV may house an autonomous or teleoperated ROV and transport that asset to an inspection site and an autonomously operative vehicle (AUV) comprising a survey system and electronics for the detection of subsea seeps or other formations and/or objects.

### BACKGROUND

Reservoirs under the continental shelf often have seeps where gas breaks through the subsurface, creating bubbles or formations on the sea floor. Often, there is a desire to locate these seeps. In addition, it is often desirable to survey subsea environments to locate subsea opportunities, e.g. a seep, a potential mining site, hydrate, a subsea wreck, or the like, or a combination thereof.

Some work has been done on trying to locate reservoirs by locating seeps associated with them. However, the costs in such a search have always been quite large. An autonomous underwater vehicle (AUV) may be used to scan the seafloor for potential targets, and then these potential sites are followed up by a survey vessel and a remotely operated vehicle (ROV) deployed to seafloor to inspect the site. The day rate costs for vessel time are prohibitive and it has not been feasible to search for seeps in this manner.

### DRAWINGS

The figures supplied herein illustrate various embodiments of the invention. Items not expressly illustrated in the drawings are not necessary for the understanding of the subject matter sought to he patented by one of ordinary skill in these arts.

FIG. 1 is a schematic view of an exemplary system;

FIG. 2 is a schematic view of an exemplary AUV; and

FIG. 3 is a schematic view of an exemplary ROV.

### DESCRIPTION OF EXEMPLARY EMBODIMENTS

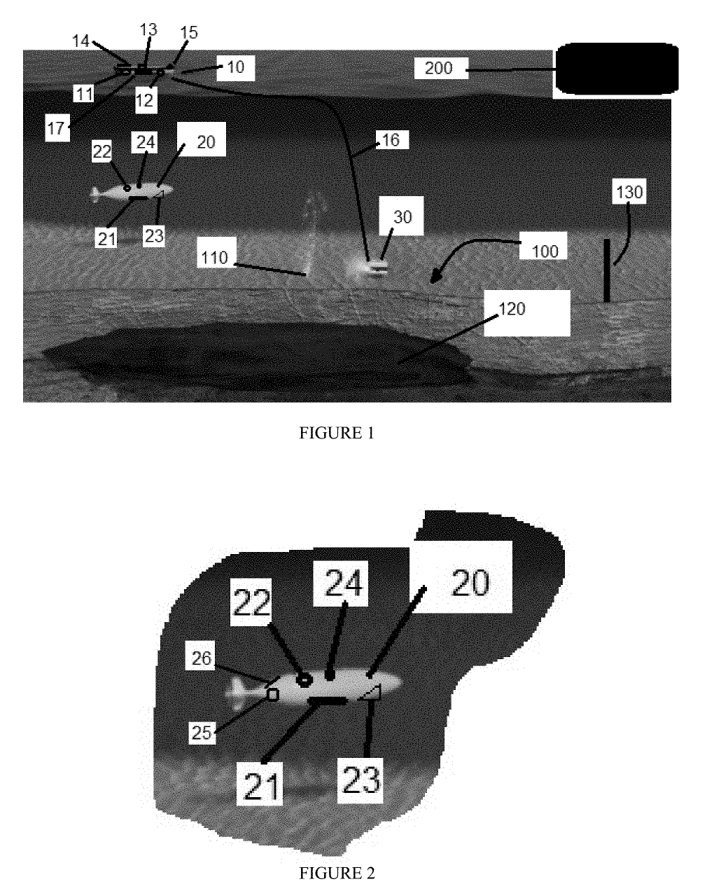

Referring now to FIG. 1, system 1, which is useful for using a combination of multiple autonomous vehicles with different abilities working together as a system for subsea oil and gas exploration, comprises autonomous surface vessel (ASV) 10, which may be launched from a shore location and/or from a vessel; autonomously operated vehicle (AUV) 20; and remotely operated vehicle (ROV) 30. In a subsea application, system 1 operates to survey or otherwise view a subsea formation such as subsea seep location 110, formation location 120, object location 130, or the like, or a combination thereof.

ASV 10 typically comprises data transceiver 11 and power source 12 operatively in communication with data transceiver 11. Data transceiver 11 is typically configured to operate as communications link to the subsea assets, e.g. AUV 20 and ROV 30, and relays data from control station 200 to the subsea assets.

In certain embodiments, ASV 10 further comprises berth 17 for AUV 20 into which AUV 20 may be selectively released or captured.

Additionally, ASV power source 12 may comprise a battery which may be rechargeable; a fuel based electric generator; a fuel cell; or the like, or a combination thereof. In certain embodiments, where the battery is rechargeable, ASV 10 may further comprise one or more solar cells 14 operatively in communication with the rechargeable battery and operative to recharge the rechargeable battery. Further, ASV 10 may further comprise power interface 15 which is typically configured to allow refueling or recharging of power source 12 from a shore location or from a vessel.

In certain embodiments, ASV 10 further comprises tether 16 which, in these configurations, allows ROV 30 to be tethered to tether 16.

Referring additionally to FIG. 2, AUV 20 typically comprises subsea survey system 21, transceiver 24 operatively in communication with subsea survey system 21, and power system 22 operatively in communication with subsea survey system 21 and with transceiver 24. AUV power source 22 may comprise battery 25, which may be rechargeable; a fuel based electric generator; a fuel cell; or the like, or a combination thereof. In embodiments, where battery 25 is rechargeable, AUV 20 may further comprise one or more solar cells 26 operatively in communication with rechargeable battery 25 and operative to recharge rechargeable battery 25.

Subsea survey system 21 may be a swappable subsea survey system, i.e. one configured to be removed and/or replaced by ASV 10 or ROV 30, and comprise a subsea formation survey package, a subsea mining opportunity survey package, a hydrate harvesting location survey package, or a treasure hunting/shipwreck site survey package, or the like, or a combination thereof. Subsea survey system 21 and its associated electronics may be used in a survey system to detect subsea seeps or other formations and/or objects.

Additionally, AUV 20 may further comprise power interface 23 configured to allow refueling or recharging of AUV power source 22 such as from a vessel or from ASV 10.

Telemetry transceiver 24 is typically in communication with AUV power source 22 and subsea survey system 21 and used to provide telemetry data to control station 200, either directly or via ASV 10, e.g. via data transceiver 11.

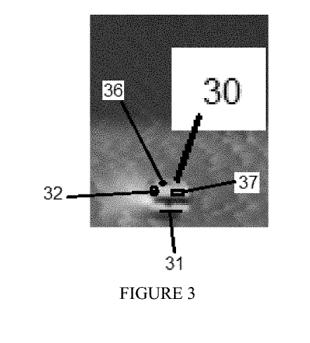

Referring additionally to FIG. 3, ROV 30 may be a flying eyeball ROV or a work class ROV and may be an autonomous ROV, a teleoperated ROV, or a hybrid mix of the two technologies capable of switching from autonomous operations to pre-programmed operation to teleoperation. ROV 30 typically comprises ROV power source 32 and ROV instrumentation package 31.

In embodiments ROV instrumentation package 31 typically further comprises a limitation inertial guidance system, a current profiler, sonar, a visual camera system, a light, or a sampling system for water, sediment, and the like, or a combination thereof

ROV power source 32 may comprise a battery, a fuel based electric generator, a fuel cell, or the like, or a combination thereof.

Where ASV 10 comprises tether 16, ROV 30 typically further comprises tether power connector 36 adapted to receive power from tether 16 and power management system 37 configured to allow ROV 30 to switch from tether power to battery power and to manage power consumption to allow for low power operation and for trickle charging from lower power recharging stations.

Referring back to FIG. 1, in addition, ROV 30 is typically adapted to return to ASV 10, return in a tethered connection to AUV 20, return to another vessel to recharge, or the like, or a combination thereof. In certain embodiments, ROV 30 is adapted to return to a nearby resident ROV (not shown in the figures) such as to recharge, upload data, and download programming/data.

In the operation of exemplary embodiments, referring back to FIG. 1, subsea surveys using system 1, which is as described above, may comprise ASV 20 which may be configured to serve as a communications link to subsea assets and relay data from control station 200 to the subsea assets, e.g. AU 20 and/or ROV 30. ASV 10 typically houses an autonomous or teleoperated ROV 30 and is further typically configured to transport an asset, e.g. ROV 30, to the sites for inspection. In addition, ASV 10 may be configured to serve as a communications link to subsea assets, e.g. AUV 20 and/or ROV 30, and to relay data from control station 200 to the subsea assets. As described above, ASV 20 may house an asset such as an autonomous or teleoperated ROV 30 and also be configured to transport that asset to sites for inspection

Surveys typically comprise deploying AUV 20 and ASV 10 to search area 100 and using AUV 20 to perform a search pattern looking for a subsea opportunity, e.g. a seep, mining site, hydrate, wreck, or the like, or a combination thereof. Telemetry may be communicated from AUV 20 back to control station 200, which may be located anywhere worldwide, either directly or via ASV 10. If something of interest is located, ASV 20 is sent to investigate potential subsea finds found by the search, e.g. a subsea opportunity (object or site or the like) of interest, such as by piloting ASV 10 to a location on or near the sea surface near the subsea find. Once ASV 10 is in that location, ROV 30 may be deployed, such as from ASV 10, and ROV 30 piloted to descend to investigate the subsea find. As noted above, ROV 30 may be operated autonomously, by pre-programmed operation, or by teleoperation and is either tethered or free swimming. ROV 30 is then used to locate and survey the subsea find and data supplied by ROV 30 relayed to control station 200, e.g. via ASV 10.

ROV 30 may be recovered to ASV 10 at a predetermined time, e.g. after ROV 30 descends and investigates the subsea find.

In embodiments, ASV 10 may be navigated to a series of subsea finds, such as after ROV 30 descends and investigates a first subsea find.

The foregoing disclosure and description of the inventions are illustrative and explanatory. Various changes in the size, shape, and materials, as well as in the details of the illustrative construction and/or an illustrative method may be made without departing from the spirit of the invention.

1) A system for using a combination of multiple autonomous vehicles with different abilities, working together as a system for subsea oil and gas exploration, comprising:
a) an autonomous surface vessel (ASV), comprising:
i) a data transceiver; and
ii) a power source operatively in communication with the data transceiver;
b) an autonomously operated vehicle (AUV), comprising:
i) a subsea survey system;
ii) a telemetry transceiver; and
iii) a power system operatively in communication with the subsea survey system and the telemetry transceiver; and
c) a remotely operated vehicle (ROV), the ROV comprising an ROV power source, the ROV cooperatively coupled to the ASV.

2) The system for using a combination of multiple autonomous vehicles with different abilities, working together as a system for subsea oil and gas exploration of claim 1, wherein the ASV further comprises a berth adapted to selectively and releasably receive the AUV.

3) The system for using a combination of multiple autonomous vehicles with different abilities, working together as a system for subsea oil and gas exploration of claim 1, wherein the subsea survey system comprises a subsea formation survey package for surveying a subsea formation.

4) The system for using a combination of multiple autonomous vehicles with different abilities, working together as a system for subsea oil and gas exploration of claim 3, wherein the subsea formation comprises a subsea seep location, a formation location, or an object location.

5) The system for using a combination of multiple autonomous vehicles with different abilities, working together as a system for subsea oil and gas exploration of claim 1, wherein the subsea survey system comprises a subsea mining opportunity survey package, a hydrate harvesting location survey package, or a treasure hunting/shipwreck site survey package.

6) The system for using a combination of multiple autonomous vehicles with different abilities, working together as a system for subsea oil and gas exploration of claim 1, wherein the ASV further comprises a power interface operatively in communication with the ASV power source, the power interface configured to allow refueling or recharging of the ASV from a shore location or from a vessel.

7) The system for using a combination of multiple autonomous vehicles with different abilities, working together as a system for subsea oil and gas exploration of claim 1, wherein the ASV power source further comprises:
a) a rechargeable battery; and
b) a solar cell operatively in communication with the rechargeable battery.

8) The system for using a combination of multiple autonomous vehicles with different abilities, working together as a system for subsea oil and gas exploration of claim 1, wherein the ASV is configured to be launched from a shore location or from a vessel.

9) The system for using a combination of multiple autonomous vehicles with different abilities, working together as a system for subsea oil and gas exploration of claim 1, wherein the AUV further comprises a power interface operatively in communication with the AUV power system, the AUV power source configured to allow refueling or recharging of the AUV from a vessel or from the ASV.

10) The system for using a combination of multiple autonomous vehicles with different abilities, working together as a system for subsea oil and gas exploration of claim 1, wherein the AUV power source further comprises:
a) a rechargeable battery; and
b) a solar cell operatively in communication with the rechargeable battery.

11) The system for using a combination of multiple autonomous vehicles with different abilities, working together as a system for subsea oil and gas exploration of claim 1, wherein the subsea survey system comprises an ASV swappable subsea survey system.

12) The system for using a combination of multiple autonomous vehicles with different abilities, working together as a system for subsea oil and gas exploration of claim 1, wherein the ROV further comprises an ROV instrumentation package configured to survey a potential subsea seep site, a subsea mining opportunity survey package, a hydrate harvesting location survey package, or a treasure hunting/shipwreck site survey package.

13) The system for using a combination of multiple autonomous vehicles with different abilities, working together as a system for subsea oil and gas exploration of claim 12, wherein the ROV instrumentation package further comprises limitation inertial guidance, a current profiler, a sonar, a visual camera system, a light, or a sampling system.

14) The system for using a combination of multiple autonomous vehicles with different abilities, working together as a system for subsea oil and gas exploration of claim 1, wherein the ROV comprises an autonomous ROV, a teleoperated ROV, or a hybrid mix of the two technologies capable of switching from autonomous operations to pre-programmed operation to teleoperation.

15) The system for using a combination of multiple autonomous vehicles with different abilities, working together as a system for subsea oil and gas exploration of claim 1, wherein the ASV further comprises:
a) a tether to which the ROV is tethered;
b) a tether power connector adapted to receive power from the tether; and
c) a power management system configured to allow the ROV to switch from tether power to battery power and to manage power consumption to allow for low power operation and for trickle charging from lower power recharging stations.

16) A survey method for using a system comprising an autonomous surface vessel (ASV) configured to serve as a communications link to subsea assets and relay data from the control station to the subsea assets, the ASV housing an autonomous or teleoperated ROV and configured to transport that asset to the sites for inspection; an autonomously operated vehicle (AUV) comprising a subsea survey system and electronics for the detection of subsea seeps or other formations and/or objects; and a remotely operated vehicle (ROV), the method comprising:
a) deploying the AUV and the ASV to a search area (100);
b) using the AUV to perform a search pattern looking for a subsea opportunity;
c) communicating telemetry from the AUV back to a control station either directly or via the ASV;
d) sending the ASV to investigate potential subsea finds found by the AUV search by piloting the ASV into location on the sea surface near a subsea find of the potential subsea finds;
e) deploying the ROV from the ASV once the ASV is in a predetermined location proximate the subsea find of the potential subsea finds;
f) piloting the ROV to descend to investigate the subsea find of the potential subsea finds autonomously, by pre-programmed operation, or by teleoperation, the ROV being tethered or free swimming;
g) using the ROV to locate and survey the subsea find of the potential subsea finds; and
h) relaying ROV supplied data to a control station via the ASV.

17) method of claim 16, further comprising recovering the ROV to the ASV at a predetermined time.

18) The method of claim 16, further comprising maneuvering the ASV to a next subsea find of the potential subsea finds.

19) The method of claim 16, further comprising returning the ROV to the ASV, to a tethered connection to the AUV, to another vessel to recharge, or to a nearby resident ROV to recharge, upload data, and download programming/data.
